(19) United States
(12) Patent Application Publication
(10) Pub. No.: US 2006/0221115 A1
(43) Pub. Date: Oct. 5, 2006

(54) Methods for bonding radiation curable compositions to a substrate

(75) Inventor: Girish S. Patil, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/095,694

(22) Filed: Apr. 1, 2005

(51) Int. Cl. B32B 37/00

(52) U.S. Cl. 347/20; 427/402; 156/272.2

(57) ABSTRACT

A method for improving adhesion of a radiation curable layer to a semiconductor chip utilizing a silane adhesion promoter, without crosslinking the silane adhesion promoter prior to application of the radiation curable layer onto the surface of the semiconductor chip.

### TECHNICAL FIELD

This invention relates to methods for improving adhesion of a radiation curable layer to a semiconductor chip, particularly useful in the formation of ink jet print heads.

### BACKGROUND OF THE INVENTION

The ink jet print head of a ink jet printer generally consists of an orifice plate containing orifices or injection parts for discharging ink for recording on a substrate, ink passageways connecting the orifices to an ink supply and an energy imparting device for ejecting ink from the print head through the orifices. The energy for discharging the ink during recording is generated in most cases by resistance elements or piezoelectric devices.

Methods for making the ink passageways for ink jet print heads include, for example, forming fine grooves in a thin layer of glass, metal or plastic by cutting or etching and then bonding another thin layer of material onto the layer having such grooves formed thereon to form liquid passageways. Another method involves forming grooves in a photosensitive resin coated on a substrate containing the energy imparting devices by photolithographic techniques. Once the grooves are formed in the photosensitive resin, another thin layer of material is attached to the grooved resin to form, for example, nozzle plates.

There are typically multiple manufacturing steps in producing an ink jet pen. For instance, resistive, conductive and insulative metal layers are typically deposited on a silicon wafer to define individual semiconductor chips. Some of the layers, such as the resistive layers are disposed on discrete locations on each chip. Accordingly, the surface of the chips, on a microscopic scale, is substantially irregular or non-planar. In the manufacturing of some ink jet print heads, a radiation curable layer is utilized to make the chip surface planer and to passivate the surface. A silane adhesion promoter is commonly used to enhance the adhesion of the radiation curable layer to the semiconductor chip. The use of an adhesion promoter typically provides significant improvement in adhesion. The adhesion promoter is applied to the semiconductor wafer before applying the radiation curable layer. It is a common practice to bake the adhesion promoter once it is applied to the substrate to help anchor the adhesion promoter onto the substrate.

The typical process utilized in the prior art for preparing a coating for a semiconductor chip involved first washing the semiconductor substrate to remove impurities. This wash may comprise a NMP (n-methylpyrrolidone) wash, a deionized water wash, and oxygen reactive ion etching to further remove any impurities on the substrate. After preparing the semiconductor substrate surface, the silane adhesion promoter is coated and spun dried on the semiconductor substrate. In the prior art, the semiconductor substrate is then baked in an oven at a temperature typically in excess of 80° C. to drive off any solvent in the silane adhesion promoter. After the bake step, the semiconductor substrate is cooled and the radiation curable resin layer is coated and spun dried in a similar manner as the silane adhesion promoter. The radiation curable layer is then exposed to radiation (ultraviolet light) through a photo mask that masks off certain regions of the semiconductor chip, such as heater regions and ink jet print head chips. The radiation cures the exposed resin layer. The uncured portions of the radiation curable layer are then removed during a developing step. Then as a final step, the semiconductor substrate is baked at a temperature of at least about 120° C. to drive off any residual acids used in the developing step. In addition, this step ensures crosslinking of the radiation curable layer to further improve its adhesion to the chip.

Some semiconductor chips, especially those utilized for ink jet print head chips, may have one or more regions on the surface below the surrounding areas. For example, a heater region may be more than 1.5 microns below its surrounding areas. This can form a trench like feature that can potentially trap excess silane adhesion promoter during the coating process and result in a thicker coating of the silane adhesion promoter on the heater. During the subsequent bake step, the silane adhesion promoter is crosslinked and can the thicker coating can lead to a relatively thick layer on any depressed area such as the heater regions. In addition, after crosslinking, this silane adhesion promoter can be very difficult to remove and can potentially cause malfunctions with the semiconductor chips functionality and as such require the semiconductor chips to be discarded. Accordingly, there is a need for an improved method of bonding a radiation curable layer to a semiconductor chip.

### SUMMARY OF THE INVENTION

The present invention comprises methods for improving adhesion of a radiation curable layer to a semiconductor chip. These methods of the present invention are particularly useful in the manufacture of print heads. More specifically, this invention relates to methods, print heads and ink jet printers with improved adhesion of a radiation curable layer to a semiconductor chip utilizing a silane adhesion promoter without a baking step to crosslink the silane adhesion promoter after coating the silane adhesion promoter on the semiconductor chip.

One embodiment of the present invention is a method for bonding a photosensitive polymer to a substrate. The method comprises coating the substrate with a silane adhesion promoter; drying the silane adhesion promoter coating, wherein the drying is accomplished without crosslinking the silane adhesion promoter; coating the silane adhesion promoter coating with a photosensitive polymer; and baking the substrate to crosslink the photosensitive polymer coating.

Another embodiment of the present invention is the method for improving adhesion of a radiation curable layer to a semiconductor chip. The method comprises applying a silane adhesion promoter to a surface of a semiconductor chip, wherein the surface comprises resistive and conductive layers; drying the silane adhesion promoter on the surface of the semiconductor chip without crosslinking the silane adhesion promoter; applying a radiation curable layer on top of the silane adhesion promoter on the surface of the semi-conductor chip; and baking the semiconductor chip with the radiation curable layer and the silane adhesion promoter layer on the surface of the semiconductor chip.

Yet another embodiment of the present invention is a method for making an ink jet pen for an ink jet printer. The method comprises: applying a silane adhesion promoter to a surface of a semiconductor chip, wherein the surface comprises resistive and conductive layers; drying the silane adhesion promoter on the surface of the semiconductor chip without crosslinking the silane adhesion promoter; applying a radiation curable layer on top of the silane adhesion promoter on the surface of the semiconductor chip; curing the radiation curable layer by exposure to actinic radiation in a pattern to thereby form a cured region of the radiation curable layer; removing any uncured regions from the radiation curable layer; baking the semiconductor chip to crosslink the cured resin layer; aligning and attaching a nozzle plate to the semiconductor chip with an adhesive to provide a nozzle plate/chip assembly; and attaching a flexible circuit to the nozzle plate/chip assembly.

Another embodiment of the present invention is an ink jet print head. The ink jet print head comprises a polymeric nozzle plate; ink passageways connected to nozzles of a nozzle plate; and a predominantly silicon substrate; wherein the ink jet print head is formed by: applying a silane adhesion promoter to a surface of a silicon substrate, wherein the silicon substrate comprises resistive and conductive layers; drying the silane adhesion promoter on the surface of the silicon substrate without crosslinking the silane adhesion promoter; applying a radiation curable layer on top of the silane adhesion promoter on the surface of the silicon substrate; curing the radiation curable layer by exposure to actinic radiation in a pattern to thereby form a cured region of the radiation curable layer; removing any uncured regions from the radiation curable layer; baking the silicon substrate to crosslink the cured resin layer; aligning and attaching the nozzle plate to the silicon substrate with an adhesive to provide a nozzle plate/chip assembly; and attaching a flexible circuit to the nozzle plate/chip assembly.

Yet another embodiment of the present invention is an ink jet printer, The ink jet printer comprises a printer frame; a print head having ink passageways for ejecting ink, wherein the print head is formed by applying a silane adhesion promoter to a surface of a silicon substrate, wherein the silicon substrate comprises resistive and conductive layers; drying the silane adhesion promoter on the surface of the silicon substrate without crosslinking the silane adhesion promoter; applying a radiation curable layer on top of the silane adhesion promoter on the surface of the silicon substrate; curing the radiation curable layer by exposure to actinic radiation in a pattern to thereby form a cured region of the radiation curable layer; removing any uncured regions from the radiation curable layer; baking the silicon substrate to crosslink the cured resin layer; aligning and attaching the nozzle plate to the silicon substrate with an adhesive to provide a nozzle plate/chip assembly; and attaching a flexible circuit to the nozzle plate/chip assembly. The ink jet printer further comprises a print head carrier assembly including a carriage for carrying the print head, the print head carrier assembly being mounted to the printer frame effecting a reciprocating movement of the print head through a printing zone during a printing operation.

### BRIEF DESCRIPTION OF THE DRAWINGS

While the specification concludes with claims particularly pointing out and distinctly claiming the present invention, it is believed the same will be better understood from the following description taken in conjunction with accompanying drawings in which:

FIG. 1 is a schematic illustration of an ink jet print head according to a first exemplary embodiment of the present invention; and

FIG. 2 is a schematic illustration of an ink jet printer according to a second exemplary embodiment of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various embodiments which are illustrated in the accompanying drawings, wherein like numerals indicate similar elements throughout the views.

One embodiment of the present invention is an improved method for bonding a radiation curable layer to a substrate. The method comprises coating the substrate with a silane adhesion promoter; drying the silane adhesion promoter coating, wherein the drying is accomplished without crosslinking the silane adhesion promoter; coating the silane adhesion promoter coating with a radiation curable polymer; and baking the substrate to crosslink the radiation curable resin coating.

As discussed above, silane adhesion promoters are commonly used to enhance bonding of the radiation curable layer to the select conductor chip. The use of an adhesion promoter provides significant improvements in adhesion, especially on parts that are soaked in inks at 60° C. for accelerated aging tests. Unfortunately, use of silane adhesion promoters can leave a residue on some semiconductor chip components, such as heaters. Presence of the residue negatively impacts heater performance and these semiconductor chips are typically discarded during the inspection process, which results in significant yield loss. The methods of the present invention solve this problem of the silane adhesion promoter creating a residue on the semiconductor chips. Moreover, the methods of the present invention have additional benefits. The method of the present invention eliminates a process step (i.e., baking the silane adhesion promoter before coating the radiation curable layer on the semiconductor chip) which results in decreased cycle time. In addition, the method of the present invention has lower costs that are associated due to the elimination of the process steps, such as equipment and labor.

While not being limited to a theory, it is believed that in order to obtain maximum adhesion of the radiation curable layer to the semiconductor chip, the radiation curable layer should be applied to the silane adhesion promoter coating as quickly as possible. In typical prior art processes, there could be a time delay between the silane adhesion promoter coating and the radiation curable layer coating as much as two to three hours. The method of the present invention reduces this time down to potentially a few seconds.

In the methods of the present invention, the semiconductor chip is not baked after application of the silane adhesion promoter to the semiconductor chip. This prevents any silane adhesion promoter that is gathered in any depression areas on the semiconductor chip, such as heater regions, from crosslinking during the bake step of the silane adhesion promoter. Without being limited by a theory, it is believed that only monolayers of the silane adhesion promoter are needed to aid in adhesion of the radiation curable layer to the semiconductor substrate. Moreover, it is believed that the excess silane adhesion promoter is taken up into the radiation curable layer during the initial coat step and can be removed during the developing step along with the uncured portions of the radiation curable layer.

In one exemplary embodiment of the present invention, the radiation curable resin layer comprises a multifunctional epoxy component, and/or a difunctional epoxy component and a photoinitiator.

Exemplary multifunctional epoxy components of the radiation curable resin layer may be selected from aromatic epoxides such as glycidyl ethers of polyphenols. One exemplary multifunctional epoxy resin is a polyglycidyl ether of phenolformaldehyde novolac resin such as the novolac epoxy resin having an epoxide equivalent weight ranging from about 172 to about 179 and a viscosity at 25° C. ranging from about 3,000 to about 5,000 centipoises, which is available from Dow Chemical Corp. of Midland, Mich. as “D.E.N. 431” In one exemplary embodiment, the amount of multifunctional epoxy resin in the radiation curable resin layer formulation ranges from about 5 to about 15 weight percent based on the weight of the cured resin, alternatively from about 8 to about 10 percent by weight based on the weight of the cured resin.

Another exemplary component of the radiation curable resin composition is a difunctional polymeric compound. The difunctional polymeric compound may comprise a difunctional epoxy compound which includes monomeric difunctional epoxy compounds and polymeric difunctional epoxy compounds which may vary in the nature of their backbone and substituent groups. In one embodiment, the difunctional polymeric compound has a hydroxy group as a substituent. Other exemplary substituent groups include, for example, halogens, ester groups, ethers, sulfonate groups, siloxane groups, nitro groups, and phosphate groups. The number average molecular weight (MN) of the difunctional polymeric compound may vary from about 75 to about 100,000. In one embodiment the difunctional polymeric compound comprises a liquid. Alternatively, one or more solid difunctional polymeric compounds may be utilized in a mixture, wherein the final mixture is in a liquid phase.

Difunctional epoxy compounds which may be used include diglycidly ethers of Bisphenol A (e.g., those available under the trade designations “EPON 828”, “EPON 1004”, “EPON 1001F”, “EPON SU-8” and “EPON 1010” from Shell Chemical Company, “DER-331”, “DER-332”, and “DER-334” from Dow Chemical Company), 3,4-epoxycyclohexylmethyl-3,4-epoxycyclohexene carboxylate (e.g., “ERL-4221” from Union Carbide Corp.), 3,4-epoxy-6-methylcyclohexylmethyl-3,4-epoxy-6-methylcyclohexene carboxylate (e.g., “ERL-4201” from Union Carbide Corp.), bis(3,4-epoxy-6-methylcyclohexylmethyl)adipate (e.g., “ERL-4289” from Union Carbide Corp.), bis(2,3-epoxyclopentyl)ether (e.g., “ERL-0400” from Union Carbide Corp.) In one exemplary embodiment the difunctional polymeric compound is present in an amount from about 5 to about 50 weight percent. In another exemplary embodiment, the difunctional polymer compound is present from about 10 to about 20 weight percent.

Another component of the radiation curable resin composition is a photoinitiator capable of generating a cation such as an aromatic complex salt photoinitiator which may be selected from onium salts of a Group VA element, onium salts of a Group VIA element, and aromatic halonium salts. These complex salts, upon being exposed to ultraviolet radiation or electron beam irradiation, are capable of generating moieties which initiate reaction with epoxides. In one exemplary embodiment, the photoinitiator is present in the composition in an amount from about 1 to about 10 weight percent. Alternatively, the photoinitiator is present in the composition in the amount from about 1.5 to about 5 weight percent, based on total weight of the resin composition.

Exemplary aromatic complex salt photoinitiators include aromatic iodonium complex salts and aromatic sulfonium complex salts. Examples of the aromatic iodonium complex salt aromatic complex salt photoinitiators include:
diphenyliodonium tetrafluoroborate
di(4-methylphenyl)iodonium tetrafluoroborate
phenyl-4-methylphenyliodonium tetrafluoroborate
di(4-heptylphenyl)iodonium tetrafluoroborate
di(3-nitrophenyl)iodonium hexafluorophosphate
di(4-chlorophenyl)iodonium hexafluorophosphate
di(naphthyl)iodonium tetrafluoroborate
di(4-trifluoromethylphenyl)iodonium tetrafluoroborate
diphenyliodonium hexafluorophosphate
di(4-methylphenyl)iodonium hexafluorophosphate
diphenyliodonium hexafluoroarsenate
di(4-phenoxyphenyl)iodonium tetrafluoroborate
phenyl-2-thienyliodonium hexafluorophosphate
3,5-dimethylpyrazolyl-4-phenyliodonium hexafluorophosphate
diphenyliodonium hexafluoroantimonate
2,2′-diphenyliodonium tetrafluoroborate
di(2,4-dichlorophenyl)iodonium hexafluorophosphate
di(4-bromophenyl)iodonium hexafluorophosphate
di(4-methoxyphenyl)iodonium hexafluorophosphate
di(3-carboxyphenyl)iodonium hexafluorophosphate
di(3-methoxycarbonylphenyl)iodonium hexafluorophosphate
di(3-methoxysulfonylphenyl)iodonium hexafluorophosphate
di(4-acetamidophenyl)iodonium hexafluorophosphate
di(2-benzoethienyl)iodonium hexafluorophosphate

In one exemplary embodiment of the present invention, the photoinitiator is either diaryliodonium hexafluorophosphate or diaryliodonium hexafluoroantimonate, or a mixture thereof. These salts are particularly useful because, in general, they are typically more thermally stable, promote faster reaction, and are more soluble in inert organic solvents than are other aromatic iodonium salts of complex ions.

Examples of aromatic sulfonium complex salt aromatic complex salt photoinitiators include:
triphenylsulfonium tetrafluoroborate
methyldiphenylsulfonium tetrafluoroborate
dimethylphenylsulfonium hexafluorophosphate
triphenylsulfonium hexafluorophosphate
triphenylsulfonium hexafluoroantimonate
diphenylnaphthylsulfonium hexafluoroarsenate
tritolysulfonium hexafluorophosphate
anisyldiphenylsulfonium hexafluoroantimonate
4-butoxyphenyldiphenylsulfonium tetrafluoroborate
4-chlorophenyldiphenylsulfonium hexafluoroantimonate
tris(4-phenoxyphenyl)sulfonium hexafluorophosphate
di(4-ethoxyphenyl)methylsulfonium hexafluoroarsenate
4-acetoxy-phenyldiphenylsulfonium tetrafluoroborate
tris(4-thiomethoxyphenyl)sulfonium hexafluorophosphate
di(methoxysulfonylphenyl)methylsulfonium hexafluoroantimonate
di(methoxynapththyl)methylsulfonium tetrafluoroborate
di(carbomethoxyphenyl)methylsulfonium hexafluorophosphate
4-acetamidophenyldiphenylsulfonium tetrafluoroborate
dimethylnaphthylsulfonium hexafluorophosphate
trifluoromethyldiphenylsulfonium tetrafluoroborate
methyl(n-methylphenothiazinyl)sulfonium hexafluoroantimonate
phenylmethylbenzylsulfonium hexafluorophosphate

In another exemplary embodiment of the present invention, the photoinitiator comprises triaryl-substituted salts such as triphenylsulfonium hexafluorophosphate. The triaryl-substituted salts are beneficial because they are typically more thermally stable than the mono- and diaryl substituted salts thereby providing a one-part system with long shelf life. The triaryl-substituted complex salts are also more amenable to dye sensitization. Consequently, the use of such complex salts results in compositions which are much more useful in applications where near ultraviolet and visible light are used for exposure. If desired, the composition may be prepared in shelf stable concentrate form (i.e. with high levels of complex salt) which is suitable for later dilution to a more commercially practical coating composition.

One exemplary photoinitiator capable of generating a cation is a mixed triarylsulfonium hexafluoroantimonate salt, commercially available from Union Carbide (UVI-6974).

Exemplary silane adhesion promoters utilized in the present invention include those having a functional group capable of reacting with at least one member selected from the group consisting of the multifunctional epoxy compound, the difunctional epoxy compound and the photoinitiator. One exemplary silane adhesion promoter comprises a silane with an epoxide functional group such as a glycidoxyalkyl-trialkoxy silane, for example, gamma-glycidoxypropyltrimethoxy silane. Another exemplary silane adhesion promoter comprises glycidoxypropyl triethoxy silane, available from Dow Chemical Corp. of Midland, Mich. as “Z6040”. Other examples of silane adhesion promoters Z-6010, Z-6030, QI 6083, Z-6075. Examples of other adhesion promoters include commercially available Titanates, Zirconates and Phosphonates.

Another component of the radiation curable resin composition is a non-photoreactive solvent. This solvent is limited only to the extend that the desired components, prior to curing are soluble in it. Exemplary non-photoreactive solvents include gamma-butyrolactone, C₁₋₆ acetates, tetrahydrofuran, low molecular weight ketones, mixtures thereof and the like.

In one exemplary embodiment, the non-photoreactive solvent is present in the composition in an amount from about 30 to about 90 weight percent of the total weight of the resin composition. In an alternative embodiment, the non-photoreactive solvent comprises from about 45 to about 75 weight percent of the total weight of the resin composition.

In another exemplary embodiment, the resin composition of a the present invention may include up to about 35 weight percent of an acrylate or methacrylate polymer which is derived from at least one acrylate or methacrylate monomer. The polymer may be a homopolymers, a copolymer, or a blend. The term “polymer” as used herein is meant to include other oligomers (e.g., materials having a number average molecular weight as low as about 1,000) as well as high polymers (which may have a number average molecular weight ranging up to about 1,000,000). In one exemplary embodiment, the number average molecular weight of the acrylate or methacrylate polymer is in the range from about 10,000 to about 60,000, and in an alternative exemplary embodiment is in the range from about 20,000 to about 30,000.

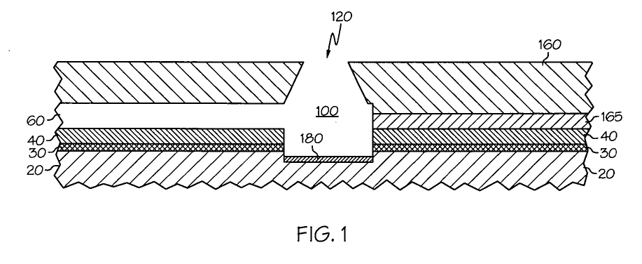

Another embodiment of the present invention, as depicted in FIG. 1, is an ink jet print head. The ink jet print head comprises a substrate 20, a silane adhesion promoter coating 30 on the substrate 20, a radiation cured resin layer 40 on the silane adhesion promoter coating 30, an ink ejection chamber 100, an orifice 120, and a passageway 60. The passageway 60 is in fluid flow communication with the orifice 120. The print head contains an energy imparting device 180 for discharging the ink through the orifice 120. Orifice 120 is in the nozzle plate 160 which is bonded 165 to the upper side of resin layer 40. Any known bonding material to one skilled in the art may be utilized to bond the nozzle plate to the resin layer. One exemplary bonding material 165 comprises phenolic butyral. The energy for discharging ink is generated by applying electronic signals to the energy imparting device 180 as desired. These energy imparting devices include heat resistance elements or piezoelectric elements which are arranged in predetermined patterns on the substrate 20. As one skilled in the art will appreciate, the radiation cured resin layer of the present invention can be utilized in various ink jet print head topographies with the resin layer ranging in thickness between about 1 micron and about 30 microns. Exemplary topographies include: 1) the resin layer being utilized as a planarizing layer with no flow features in the resin layer and having a nozzle plate with flow features and nozzles defined in the nozzle plate; 2) the resin layer having flow features formed into the resin layer and having a nozzle plate with no flow features; or 3) the resin layer having flow features formed into the resin layer and having a nozzle plate with flow features and nozzles defined in the nozzle plate.

In order to apply the silane adhesion promoter and radiation curable resin layers to the surface of the semiconductor chip, a silicon wafer is centered on an appropriate sized chuck of either a resist spinner or conventional wafer resist deposition track. The silane adhesion promoter is either dispensed by hand or mechanically into the center of the wafer. The chuck holding the wafer is then rotated to a predetermined number of revolutions per minute to evenly spread the silane adhesion promoter from the center of the wafer to the edge of the wafer. The rotational speed of the wafer may be adjusted or the viscosity of the silane adhesion promoter coating may be altered to vary the resulting silane adhesion promoter film thickness. In one exemplary embodiment, rotational speeds of 2,500 rpm or more may be utilized. The amount of silane adhesion promoter applied to the surface of the semiconductor chip should be sufficient to substantially coat the surface of the semiconductor substrate. While not being limited to a theory, it is believed that a monolayer coating of the silane adhesion promoter is sufficient to enhance the adhesion of the radiation curable resin layer to the semiconductor chip. After the silane adhesion promoter is coated and spun dried on the semiconductor substrate, the radiation curable resin formulation is either dispensed by hand or mechanically into the center of the semiconductor substrate. In a manner similar to the coating of the silane adhesion promoter, the chuck holding the wafer is then rotated a predetermined number of revolutions per minute to evenly spread the radiation curable resin formulation from the center of the wafer to the edge of the wafer.

In order to define patterns in the radiation curable resin layer, such as the heater resistor area, the layer is masked, exposed to a radiation source, and then developed producing the final pattern by removing the uncured material. Curing of the radiation curable resin of the present invention occurs on exposure of the radiation curable resin layer to any suitable source of radiation admitting actinic radiation at a wavelength within the ultraviolet and visible spectral regions. Exemplary exposure times may be from about 1 second to 10 minutes or more, alternatively from about 5 seconds to about 1 minute, depending on the amounts of particular epoxy materials and aromatic complex salts being utilized and depending upon the radiation source and distance from the source and the thickness of the layer to be cured. Alternatively, the radiation curable resin layer may be cured to exposure to electron beam irradiation. This procedure is very similar to a standard semiconductor lithographic process. The mask is a clear kind of flat substrate usually glass or quartz with opaque areas defining the pattern to be removed from the layer (i.e., negative acting photoresist). The opaque areas prevent the ultraviolet light from crosslinking the layer masked beneath it. The exposed layer is baked at a temperature of at least about 80° C. for about 30 seconds to about 10 minutes, in one exemplary embodiment from about 1 to about 5 minutes to complete curing of the resin layer.

The non-crosslinked material on the resin layer is then solubilized by a developer and the solubilized material is removed leaving the predetermined pattern behind on the chip surface. The developer comes in contact with the coated silicon wafer through either immersion and agitation in a tank like setup or by spray. Either spray or immersion of the wafer should adequately remove the excess material as defined by the photo masking and exposure. Illustrative developers include, for example, butyl cellosolve acetate, a xylene and butyl cellosolve acetate mixture and C₁₋₆ acetates like butyl acetate. After developing the layer, the wafer containing the layer is baked at a temperature ranging from about 150° C. to about 200° C. for a period of about 1 minute to about 60 minutes.

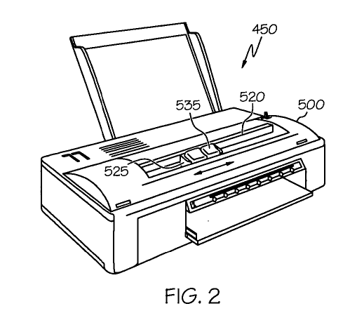

Another embodiment of the present invention, as depicted in FIG. 2 is an ink jet printer 450. The ink jet printer 450 comprises a printer frame 500, a print head 535 having ink passageways for injecting ink, wherein the ink passageways are formed by applying a silane adhesion promoter to a surface of a silicon substrate; drying the silane adhesion promoter on the surface of the silicon substrate without crosslinking the silane adhesion promoter; applying a radiation curable layer on top of the silane adhesion promoter on the surface of the silicon substrate; exposing the radiation curable layer to radiation in a pattern to cure the radiation curable layer in the pattern to thereby form a cured region of the radiation curable layers; removing any uncured regions from the radiation curable layer; and baking the silicon substrate with the cured regions of the radiation curable layer and the silane adhesion promoter layer to further crosslink the cured resin layer. The ink jet printer 450 further comprises a print head carrier assembly 520 including a carriage 525 for carrying the print head 535, the print head carrier assembly 520 being mounted onto the printer frame 500, wherein the print head carrier assembly 520 effecting a reciprocating movement of a print head 535 through a printing zone during a printing operation.

Experiment

Exemplary nozzle plate chip assemblies utilized in the present invention are soaked in ink at 60° C. for eight weeks. Throughout the eight week period, nozzle plate peel forces and failure interfaces are measured and found to be comparable to parts that were made using the prior art process involving the cross-linking of the silane adhesion promoter. At the end of the eight weeks, the peel strength numbers are approximately 200 grams.

While particular embodiments of the present invention have been illustrated and described, it would be obvious to those skilled in the art that various other changes and modifications can be made without departing from the spirit and scope of the invention. It is therefore intended to cover in the impended claims all such modifications and changes that are within the scope of the invention.

What we claim:

1. A method for bonding a photosensitive polymer to a substrate, comprising:
coating the substrate with a silane adhesion promoter;
drying the silane adhesion promoter coating, wherein the drying is accomplished without crosslinking the silane adhesion promoter;
coating the silane adhesion promoter coating with a photosensitive polymer;
and baking the substrate with the silane adhesion promoter coating and the photosensitive polymer coatings.

2. The method of claim 1, wherein drying the silane adhesion promoter is accomplished without heating the silane adhesion promoter.

3. A method for improving adhesion of a radiation curable layer to a semiconductor chip, comprising:
applying a silane adhesion promoter to a surface of the semiconductor chip, wherein the surface comprises resistive and conductive layers;
drying the silane adhesion promoter on the surface of the semiconductor chip without crosslinking the silane adhesion promoter;
applying a radiation curable layer on top of the silane adhesion promoter on the surface of the semiconductor chip; and
baking the semiconductor chip with the radiation curable layer and the silane adhesion promoter layer on the surface of the semiconductor chip.

4. The method of claim 3, wherein drying the silane adhesion promoter is accomplished without heating the silane adhesion promoter.

5. The method of claim 3, further comprising curing the radiation curable layer by exposure to actinic radiation to provide a cured resin layer.

6. A method for making an ink jet pen for an ink jet printer comprising:
applying a silane adhesion promoter to a surface of the semiconductor chip, wherein the surface comprises resistive and conductive layers;
drying the silane adhesion promoter on the surface of the semiconductor chip without crosslinking the silane adhesion promoter;
applying a radiation curable layer on top of the silane adhesion promoter on the surface of the semiconductor chip;
curing the radiation curable layer by exposure to actinic radiation in a pattern to thereby form a cured region of the radiation curable layer;
removing any uncured regions from the radiation curable layer;
baking the semiconductor chip to crosslink the cured resin layer;
aligning and attaching a nozzle plate to the semiconductor chip with an adhesive to provide a nozzle plate/chip assembly; and
attaching a flexible circuit to the nozzle plate/chip assembly.

7. The method of claim 6, wherein drying the silane adhesion promoter is accomplished without heating the silane adhesion promoter.

8. A print head for an ink jet printer comprising an ink jet pin made by the method of claim 6.

9. The method of claim 1, wherein the photosensitive polymer comprises a multifunctional epoxy component and a photoinitiator.

10. The method of claim 1, wherein the photosensitive polymer comprises a difunctional epoxy component and a photoinitiator.

11. The method of claim 10, wherein the difunctional epoxy component has a weight average molecular weight of at least 2500.

12. The method of claim 1, wherein the photosensitive polymer comprises a multifunctional epoxy component, a difunctional epoxy component and a photoinitiator.

13. The method of claim 12, wherein the photoinitiator comprises an aryl sulfonium salt.

14. The method of claim 9, wherein the multifunctional epoxy component comprises a polyglycidyl ether of phenolformaldehyde novolac resin.

15. The method of claim 10, wherein the difunctional epoxy component comprises a bisphenol-A/epicholohydrin epoxy.

16. The method of claim 10, wherein the photosensitive polymer comprises from about 60 to about 85 weight percent of the difunctional epoxy component and from about 12 to about 22 weight percent of the photoinitiator.

17. The method of claim 1, wherein the silane adhesion promoter comprises gamma-glycidoxypropyltrimethoxysilane.

18. The method of claim 1, wherein the silane adhesion promoter comprises glycidoxypropyl triethoxy silane.

19. The method of claim 3, wherein the silane adhesion promoter comprises gamma-glycidoxypropyltrimethoxysilane.

20. The method of claim 3, wherein the silane adhesion promoter comprises glycidoxypropyl triethoxy silane.

21. The method of claim 6, wherein the silane adhesion promoter comprises gamma-glycidoxypropyltrimethoxysilane.

22. The method of claim 5, wherein the silane adhesion promoter comprises glycidoxypropyl triethoxy silane.

23. An ink jet printer, comprising:
a printer frame;
a print head having ink passageways for ejecting ink, wherein the print head is formed by:
applying a silane adhesion promoter to a surface of a silicon substrate, wherein the silicon substrate comprises resistive and conductive layers;
drying the silane adhesion promoter on the surface of the silicon substrate without crosslinking the silane adhesion promoter;
applying a radiation curable layer on top of the silane adhesion promoter on the surface of the silicon substrate; curing the radiation curable layer by exposure to actinic radiation in a pattern to thereby form a cured region of the radiation curable layer;
removing any uncured regions from the radiation curable layer;
baking the silicon substrate to crosslink the cured resin layer;
aligning and attaching the nozzle plate to the silicon substrate with an adhesive to provide a nozzle plate/chip assembly; and
attaching a flexible circuit to the nozzle plate/chip assembly; and
a print head carrier assembly including a carriage for carrying a print head, the print head carrier assembly being mounted to the printer frame effecting a reciprocating movement of the print head through a printing zone during a printing operation.

24. The ink jet printer of claim 23, wherein the silane adhesion promoter comprises gamma-glycidoxypropyltrimethoxysilane.

25. The ink jet printer of claim 23, wherein the silane adhesion promoter comprises glycidoxypropyl triethoxy silane.

26. The ink jet printer of claim 23, wherein the ink passageways are formed in the radiation curable layer.

27. The ink jet print head of claim 6, wherein the silane adhesion promoter comprises glycidoxypropyl triethoxy silane.

28. The ink jet print head of claim 6, wherein the silane adhesion promoter comprises glycidoxypropyl triethoxy silane.

29. An ink jet print head having ink passage ways, wherein the print head is formed by:
applying a silane adhesion promoter to a surface of a silicon substrate, wherein the silicon substrate comprises resistive and conductive layers;
drying the silane adhesion promoter on the surface of the silicon substrate without crosslinking the silane adhesion promoter;
applying a radiation curable layer on top of the silane adhesion promoter on the surface of the silicon substrate; curing the radiation curable layer by exposure to actinic radiation in a pattern to thereby form a cured region of the radiation curable layer;
removing any uncured regions from the radiation curable layer;
baking the silicon substrate to crosslink the cured resin layer;
aligning and attaching the nozzle plate to the silicon substrate with an adhesive to provide a nozzle plate/chip assembly; and
attaching a flexible circuit to the nozzle plate/chip assembly.

30. The ink jet print head of claim 29, wherein the ink passageways are formed in the radiation curable layer.
